(19) United States
(12) Patent Application Publication
(10) Pub. No.: US 2020/0331789 A1
(43) Pub. Date: Oct. 22, 2020

(54) METHOD FOR PRODUCING GLASS ARTICLE AND GLASS-MELTING FURNACE

(71) Applicant: Nippon Electric Glass Co., Ltd., Shiga (JP)

(72) Inventors: Toru SAKURABAYASHI, Shiga (JP); Toru HASEGAWA, Shiga (JP)

(21) Appl. No.: 16/955,229

(22) PCT Filed: Nov. 28, 2018
(86) PCT No.: PCT/JP2018/043733

§ 371 Date: Jun. 18, 2020

(30) Foreign Application Priority Data
Dec. 22, 2017 (JP) 2017-246497

(51) Int. Cl. C03B 5/03; C03B 17/06; C03B 5/173; F27D 7/02; F27B 3/08

(52) U.S. Cl. CPC C03B 5/03; C03B 17/06; F27B 3/08; F27D 7/02; C03B 5/173

(57) ABSTRACT

Provided is a manufacturing method for a glass article, including: a glass melting step of continuously melting glass raw materials (Gr) in a glass melting furnace (1) by heating (electric heating) through application of a current with an electrode (11) to generate a molten glass (Gm); and a forming step of forming the molten glass (Gm) into a sheet glass by a down-draw method. The glass melting step includes adjusting a water vapor amount in an atmosphere in the glass melting furnace (1) to 15 g/Nm³ or less.

### TECHNICAL FIELD

The present invention relates to a manufacturing method for a glass article and a glass melting furnace.

### BACKGROUND ART

In a manufacturing process for a glass article, such as a sheet glass, a glass melting furnace is used for melting glass raw materials to generate molten glass serving as a source for the glass article.

As the glass melting furnace, a furnace of a type in which the glass raw materials are melted by gas combustion is widely utilized, but in some cases, a furnace of a type in which the glass raw materials are melted only by electric heating is used (see Patent Literature 1).

### CITATION LIST

Patent Literature 1: JP 2003-183031 A

### SUMMARY OF INVENTION

### Technical Problem

In recent years, film forming and patterning have been performed on a sheet glass with higher definition, and when the sheet glass has poor thermal dimensional stability, a positional shift is liable to occur during the film forming and patterning. Accordingly, it is often the case that the glass article, such as a sheet glass, is required to have high thermal dimensional stability. One indicator of the thermal dimensional stability is compaction determined based on a difference in dimensions of the glass article before and after heat treatment, and a smaller value for the compaction means that the glass article has high thermal dimensional stability. The compaction is closely correlated with a water amount in the glass article, and as the water amount in the glass article is smaller, the strain point of glass tends to be increased more, and the value for the compaction tends to be reduced more.

In a glass melting furnace utilizing gas fuel combustion, the gas fuel combustion is always performed in the furnace. Therefore, a water vapor amount in an atmosphere in the furnace is substantially dominated by a water vapor amount in a combustion waste gas, and is kept at a relatively high level. When the water vapor amount in the atmosphere in the glass melting furnace is high as described above, also a water amount in molten glass in the furnace tends to be increased. Accordingly, a water amount in a glass article to be manufactured from the molten glass is inevitably increased, resulting in a problem in that the value for the compaction of the glass article cannot be reduced.

Meanwhile, a glass melting furnace utilizing only electric heating does not involve an increase in water vapor amount resulting from, for example, gas fuel combustion in the furnace, and hence the water amount in the molten glass is easily reduced as compared to the case of the glass melting furnace utilizing gas combustion. Accordingly, the water amount in the glass article to be manufactured from the molten glass is inevitably reduced, resulting in an advantage in that the value for the compaction of the glass article can be reduced.

However, in recent years, the value for the compaction of the glass article has been required to be further reduced, and even in the case of the glass melting furnace utilizing only electric heating, the water amount in the molten glass has been required to be further reduced.

An object of the present invention is to reduce a water amount in molten glass to the extent possible in a glass melting furnace configured to melt glass raw materials only by electric heating.

### Solution to Problem

According to one embodiment of the present invention, which has been devised to achieve the above-mentioned object, there is provided a manufacturing method for a glass article, comprising: a glass melting step of continuously melting glass raw materials in a glass melting furnace only by electric heating to generate molten glass; and a forming step of forming the molten glass into a glass article, wherein the glass melting step comprises adjusting a water vapor amount in an atmosphere in the glass melting furnace. With such configuration, the glass raw materials are melted in the glass melting furnace only by electric heating, and hence the water vapor amount in the atmosphere in the glass melting furnace is reduced easily. Besides, the water vapor amount in the atmosphere in the glass melting furnace is adjusted, and hence the water vapor amount in the atmosphere in the glass melting furnace can be further reduced. Accordingly, a phenomenon in which water in the atmosphere in the glass melting furnace diffuses into the molten glass is less liable to occur, and a phenomenon in which water in the molten glass diffuses into the atmosphere in the glass melting furnace easily occurs. Thus, a water amount in the molten glass can be reduced to the extent possible, and a glass article with low compaction can be manufactured.

In the above-mentioned configuration, it is preferred that the glass melting step comprise adjusting the water vapor amount in the atmosphere in the glass melting furnace to 15 g/Nm³ or less. With this, the water vapor amount in the atmosphere in the glass melting furnace falls within an appropriate range, and the water amount in the molten glass can be further reduced.

In the above-mentioned configuration, the glass melting step may comprise adjusting the water vapor amount in the atmosphere in the glass melting furnace by suppling a dry gas into the glass melting furnace. With this, the atmosphere in the glass melting furnace is replaced with the dry gas, and hence the water vapor amount in the atmosphere in the glass melting furnace can be easily and reliably reduced.

In this case, it is preferred that, in the glass melting step, the molten glass comprise an exposed portion in which a liquid surface thereof is exposed without being covered with the glass raw materials, and the dry gas be supplied into the glass melting furnace at a position corresponding to the exposed portion. With this, the dry gas is actively supplied to the exposed portion of the molten glass, and hence the water vapor amount in the atmosphere above the exposed portion of the molten glass can be reliably reduced. The exposed portion of the molten glass is easily affected by the atmosphere in the glass melting furnace as compared to a portion of the molten glass covered with the glass raw materials. Accordingly, when the water vapor amount in the atmosphere above the exposed portion of the molten glass is reduced as described above, the water amount in the molten glass is easily reduced.

In the above-mentioned configuration, it is preferred that the glass melting step further comprise adjusting a difference in pressure between the atmosphere in the glass melting furnace and an atmosphere outside the glass melting furnace to from −10 mm H₂O to 10 mm H₂O. With this, the difference in pressure inside and outside the glass melting furnace is kept to fall within an appropriate range, and hence a temperature of the glass melting furnace is easily kept at a desired temperature. Accordingly, the glass raw materials can be stably continuously melted in the glass melting furnace, and hence the glass article with low compaction can be stably manufactured.

In the above-mentioned configuration, it is preferred that the forming step comprise forming the molten glass into a sheet glass by a down-draw method. The down-draw method enables forming of the sheet glass having a smooth surface, and hence a glass substrate excellent in surface quality can be efficiently manufactured.

In the above-mentioned configuration, it is preferred that the molten glass be alkali-free glass. When the molten glass is alkali-free glass, the characteristics of an amorphous silicon or polycrystalline silicon thin film can be prevented from being damaged in a manufacturing process for an electronic device, and hence a glass article suitable for a glass substrate can be manufactured.

According to one embodiment of the present invention, which has been devised to achieve the above-mentioned object, there is provided a glass melting furnace, which is configured to melt glass raw materials only by electric heating to generate molten glass, and which comprises an adjusting part configured to adjust a water vapor amount in an atmosphere in the furnace. With such configuration, the same action and effect as those obtained in the corresponding configuration described above can be obtained.

In the above-mentioned configuration, it is preferred that the adjusting part comprise a gas supply part configured to supply a dry gas into the furnace.

### Advantageous Effects of Invention

According to the present invention, the water amount in the molten glass can be reduced to the extent possible in the glass melting furnace configured to melt glass raw materials only by electric heating.

### BRIEF DESCRIPTION OF DRAWINGS

FIG. 1 is a side view for illustrating a manufacturing apparatus for a glass article.

FIG. 2 is a sectional view for illustrating a glass melting furnace of the manufacturing apparatus for a glass article of FIG. 1.

### DESCRIPTION OF EMBODIMENTS

Now, embodiments of a manufacturing method for a glass article and a glass melting furnace are described with reference to the attached drawings.

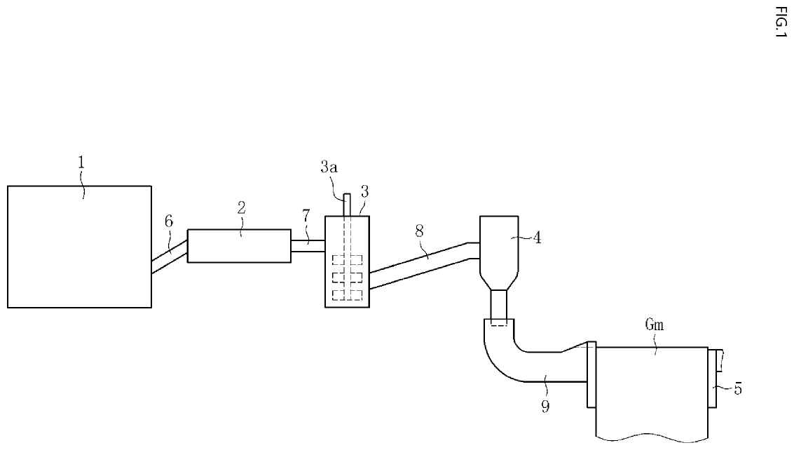

As illustrated in FIG. 1, a manufacturing apparatus for a glass article to be used for the manufacturing method of this embodiment comprises: a glass melting furnace 1; a fining chamber 2; a homogenization chamber (stirring chamber) 3; a pot 4; and a forming body 5 in the stated order from an upstream side, and these constituents 1 to 5 are connected to each other through transfer pipes 6 to 9. The terms “chamber” of the fining chamber 2 or the like and “pot” as used herein each encompass one having a bath-like structure and one having a tubular structure.

The glass melting furnace 1 is a space for performing a melting step of obtaining a molten glass Gm. Herein, for example, alkali-free glass may be used as the molten glass Gm. The alkali-free glass preferably comprises as a glass composition, in terms of mass %, 50% to 70% of SiO₂, 12% to 25% of Al₂O₃, 0% to 12% of B₂O₃, 0% to less than 1% of Li₂O+Na₂O+K₂O (the total content of Li₂O, Na₂O, and K₂O), 0% to 8% of MgO, 0% to 15% of CaO, 0% to 12% of SrO, and 0% to 15% of BaO. Out of the alkali-free glasses, glass having a high strain point is more preferred. The glass having a high strain point preferably comprises as a glass composition, in terms of mass %, 58% to 65% of SiO₂, 12% to 23% of Al₂O₃, 0% to 3% (particularly 0.1% to less than 2%) of B₂O₃, 0% to less than 1% (particularly 0% to 0.5%) of Li₂O+Na₂O+K₂O, 0.1% to 6% (particularly 2% to 5%) of MgO, 2% to 12% (particularly 3% to 10%) of CaO, 0% to 5% of SrO, and 2% to 15% (particularly 5% to 12%) of BaO. With this, the strain point is easily increased to 730° C. or more, and a reduction in compaction of a glass article is easily achieved. The molten glass Gm is not limited to the alkali-free glass.

The fining chamber 2 is a space for performing a fining step of fining (degassing) the molten glass Gm supplied from the glass melting furnace 1 through the action of a fining agent or the like.

The homogenization chamber 3 is a space for performing a homogenization step of stirring, with a stirring blade 3a, the molten glass Gm having been fined to homogenize the molten glass Gm. The homogenization chamber 3 may have a plurality of homogenization chambers connected to one another. In this case, it is preferred that, out of two homogenization chambers adjacent to each other, an upper end portion of one of the homogenization chambers be connected to a lower end portion of the other one of the homogenization chambers.

The pot 4 is a space for performing a state adjustment step of adjusting the state (e.g., viscosity) of the molten glass Gm so as to be suitable for forming. The pot 4 may be omitted.

The forming body 5 forms a forming device, and is a component for performing a forming step of forming the molten glass Gm into a desired shape. In this embodiment, the forming body 5 is configured to form the molten glass Gm into a strip-shaped glass ribbon by an overflow down-draw method.

The forming body 5 has a substantially wedge shape in a sectional shape (sectional shape perpendicular to the drawing sheet), and has an overflow groove (not shown) formed on an upper portion thereof. After the molten glass Gm is supplied to the overflow groove through the transfer pipe 9, the forming body 5 is configured to cause the molten glass Gm to overflow from the overflow groove to flow down along both side wall surfaces (side surfaces located on a front surface side and a back surface side of the drawing sheet) of the forming body 5. Moreover, the forming body 5 is configured to cause the molten glasses Gm having flowed down to join each other at lower end portions of the side wall surfaces. With this, the molten glass Gm is formed into a strip-shaped glass ribbon. The glass ribbon having been formed is subjected to treatments, such as annealing and cutting, to thereby manufacture, as the glass article, a sheet glass or a glass roll in which the glass ribbon is taken up. The thickness of the glass ribbon is, for example, from 0.01 mm to 2 mm (preferably from 0.1 mm to 1 mm). The sheet glass or the glass roll is utilized for a flat panel display, such as a liquid crystal display or an OLED display, a substrate of an OLED illumination or a solar cell, or a protective cover. The forming device may be a device for performing any other down-draw method, such as a slot down-draw method, or a float method.

The transfer pipes 6 to 9 are each formed of, for example, a tubular pipe made of platinum or a platinum alloy, and are each configured to transfer the molten glass Gm in a lateral direction (substantially horizontal direction). The transfer pipes 6 to 9 are heated through application of a current as required.

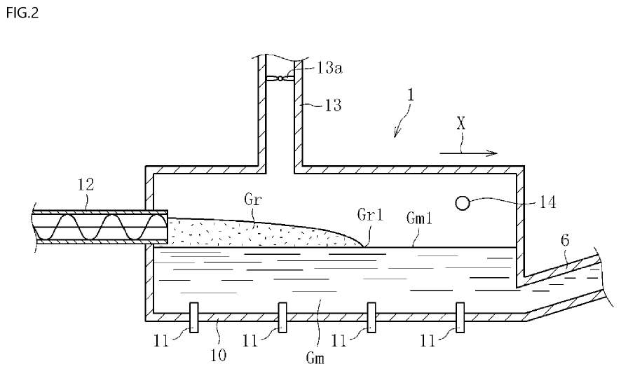

As illustrated in FIG. 2, the glass melting furnace 1 is configured to continuously melt glass raw materials (cullet may be included) Gr only by electric heating to generate the molten glass Gm. The molten glass Gm is continuously discharged through the transfer pipe 6. In FIG. 2, the arrow X represents a flowing direction of the molten glass Gm. In the glass melting furnace 1, a melting space in the furnace is partitioned with a wall part formed of a refractory brick (e.g., a zirconia-based electrocast brick, an alumina-based electrocast brick, an alumina-zirconia-based electrocast brick, an AZS (Al—Zr—Si)-based electrocast brick, or a dense fired brick).

In order to directly electrically heat (heat through application of a current) the molten glass Gm to melt the glass raw materials Gr, a plurality of rod-shaped electrodes 11 are mounted to a bottom wall part 10 of the glass melting furnace 1 under the state in which the plurality of electrodes 11 are immersed in the molten glass Gm. In this embodiment, heating means other than the electrode 11 is not mounted to the glass melting furnace 1, and the glass raw materials Gr are melted only by electric heating (electric energy) with the electrode 11 (full electric melting). In other words, gas fuel combustion, which causes an increase in water vapor amount in an atmosphere in the glass melting furnace 1, is not used. In a stage before the continuous melting is started (e.g., at the time of start-up of the glass melting furnace 1), the molten glass Gm and/or the glass raw materials Gr may be heated with, for example, a burner (gas fuel combustion) mounted to a side wall part.

The electrode 11 is formed of, for example, molybdenum (Mo). The shape of the electrode 11 is not limited to a rod shape, and may be a sheet shape, a block shape, or a combination thereof. In addition, the mounting position of the electrode 11 is not limited to the bottom wall part 10, and the electrode 11 may be mounted to the side wall part or to both the bottom wall part 10 and the side wall part. In addition, before and/or after the continuous melting is started, in order to indirectly electrically heat the glass raw materials Gr and the molten glass Gm through the atmosphere in the glass melting furnace 1, electric heating means, such as a heater, may be separately arranged to a portion of the glass melting furnace 1 above the molten glass Gm.

The glass melting furnace 1 comprises a screw feeder 12 serving as a raw material supply part. The screw feeder 12 is configured to continuously supply the glass raw materials (solid raw materials) Gr so as to form a portion prevented from being covered with the glass raw materials Gr in part of a liquid surface of the molten glass Gm, that is, an exposed portion Gm1 of the molten glass Gm. That is, the glass melting furnace 1 is of a so-called semi-hot top type. The “portion covered with the glass raw materials Gr” as used herein means a portion in which particles of the glass raw materials Gr are present on the liquid surface of the molten glass Gm. The “exposed portion Gm1” means a portion in which the particles of the glass raw materials Gr are melted and are not present on the liquid surface of the molten glass Gm. Those two portions may be discriminated from each other, for example, by picking up an image of the liquid surface of the molten glass Gm with an image pickup unit, such as a camera, and using the brightness. In addition, it is also appropriate to actually collect a sample in the vicinity of the liquid surface of the molten glass Gm, and evaluate the presence or absence of the particles of the glass raw materials Gr.

The glass melting furnace 1 may be of a so-called cold top type in which the liquid surface of the molten glass Gm is entirely covered with the glass raw materials Gr. In addition, the raw material supply part may be a pusher or a vibrating feeder.

The glass melting furnace 1 comprises a gas duct 13 serving as an exhaust passage configured to discharge an atmosphere in the furnace to an outside. The gas duct 13 comprises a fan 13a configured to send the gas (atmosphere) to the outside. However, the fan 13a may not be necessarily arranged.

The glass melting furnace 1 comprises a gas supply port 14 configured to supply a dry gas into the furnace. The gas supply port 14 is connected to a gas supply facility (e.g., a gas tank) (not shown) configured to generate or store the dry gas. Accordingly, a gas supply part comprises the gas supply facility and the gas supply port 14. The gas supply part functions as an adjusting part configured to adjust the water vapor amount in the atmosphere in the furnace, that is, the atmosphere above the molten glass Gm. In addition, the glass melting furnace 1 comprises one melting space configured to melt the glass raw materials Gr. While the glass raw materials Gr remaining unmelted are present in a space above the molten glass Gm included in the melting space, the dry gas is supplied through the gas supply port 14.

As the dry gas, for example, a gas having a low water amount, such as a dry air (dehumidified air), dry nitrogen, dry oxygen, a dry carbon dioxide gas, a dry nitric acid gas, or nitrogen oxide, or a mixed gas of two or more kinds arbitrarily selected from these gases may be used. In this embodiment, a dry air (e.g., clean dry air (CDA)), which is available inexpensively, is used.

In this embodiment, the gas supply port 14 is arranged to a position corresponding to the exposed portion Gm1 of the molten glass Gm, that is, a position on a downstream side with respect to a downstream end Gr1 of the glass raw materials Gr in a flow direction X. Specifically, the gas supply port 14 is arranged symmetrically to both side wall parts of the glass melting furnace 1 so as to reduce variation in supply amount of the dry gas in a width direction (direction perpendicular to the flow direction X) of the glass melting furnace 1. The position of the gas supply port 14 is not particularly limited, and the gas supply port 14 may be arranged at one position or a plurality of positions.

Next, the manufacturing method for a glass article using the manufacturing apparatus having the above-mentioned configuration is described.

As described above, the manufacturing method of this embodiment comprises: a melting step; a fining step; a homogenization step; a state adjustment step; and a forming step. The fining step, the homogenization step, the state adjustment step, and the forming step are as described in the configuration of the manufacturing apparatus, and hence the melting step is described below.

As illustrated in FIG. 2, in the melting step, the glass raw materials Gr are continuously melted by heating the molten glass Gm through application of a current with the electrode 11 immersed in the molten glass Gm. At this time, the dry gas is supplied from the gas supply port 14 into the glass melting furnace 1 to replace the atmosphere in the glass melting furnace 1 with the dry gas. With this, the water vapor amount in the atmosphere in the glass melting furnace 1 is adjusted. With this, while the water vapor amount in the atmosphere in the glass melting furnace 1 is originally in a small state by the effect of the full electric melting, the water vapor amount in the atmosphere in the glass melting furnace 1 becomes a much smaller state by the effect of the dry gas. Accordingly, a phenomenon in which water in the atmosphere in the glass melting furnace diffuses into the molten glass Gm is less liable to occur, and a phenomenon in which water in the molten glass Gm diffuses into the atmosphere in the glass melting furnace 1 easily occurs. Thus, the water amount in the molten glass Gm can be further reduced as compared to the case of using only the effect of the full electric melting without adjusting the water vapor amount in the atmosphere in the glass melting furnace 1. Therefore, a water amount in a sheet glass to be formed from such molten glass Gm is also in an extremely small state, and the value for compaction thereof is significantly reduced.

Herein, the dry gas may be preheated before supplied from the gas supply port 14 into the glass melting furnace 1. With this, a reduction in temperature of the furnace or occurrence of an air draft can be suppressed by the dry gas supplied into the glass melting furnace 1. The dry gas is preferably preheated so that the dry gas has a temperature of, for example, from 100° C. to 1,000° C. in the vicinity of the gas supply port 14.

In addition, a difference in pressure between the atmosphere in the glass melting furnace 1 and an atmosphere (atmospheric air) outside the glass melting furnace 1 is adjusted, for example, by adjusting a gas supply amount from the gas supply port 14 and a gas discharge amount from the gas duct 13. In the case where a dry gas at normal temperature is supplied into the glass melting furnace 1, when the difference in pressure inside and outside the glass melting furnace 1 is less than −10 mm H₂O or more than 10 mm H₂O, the temperature of the atmosphere in the glass melting furnace 1 is reduced along with an increase in gas supply amount or gas discharge amount, with the result that the temperature of the molten glass Gm is liable to be reduced. From the viewpoint of preventing such situation and easily keeping the temperature of the molten glass Gm at a desired temperature, the difference in pressure inside and outside the glass melting furnace 1 is preferably adjusted to from −10 mm H₂O to 10 mm H₂O. The difference in pressure inside and outside the glass melting furnace 1 is adjusted as described below. When the pressure of the atmosphere in the glass melting furnace 1 is relatively too high, the gas supply amount is reduced and/or the gas discharge amount is increased in order to reduce the pressure of the atmosphere in the glass melting furnace 1. In contrast, when the pressure of the atmosphere in the glass melting furnace 1 is relatively too low, the gas supply amount is increased and/or the gas discharge amount is reduced in order to increase the pressure of the atmosphere in the glass melting furnace 1.

From the viewpoint of further reducing the water amount in the molten glass, the water vapor amount in the atmosphere in the glass melting furnace 1 having been adjusted by the dry gas is preferably 15 g/Nm³ or less, more preferably 10 g/Nm³ or less, particularly preferably 5 g/Nm³ or less. From the viewpoint of adjusting the water vapor amount in the atmosphere in the glass melting furnace 1 to fall within the above-mentioned range, the water vapor amount in the dry gas is preferably 15 g/Nm³ or less, more preferably 10 g/Nm³ or less, particularly preferably 5 g/Nm³ or less. When the glass melting furnace 1 is pressurized (the above-mentioned difference in pressure has a positive value), the water vapor amount in the atmosphere in the pressurized glass melting furnace 1 is higher than the water vapor amount in the dry gas supplied at the atmospheric pressure. Therefore, when the glass melting furnace 1 is pressurized, the water vapor amount in the dry gas is set to be lower than the water vapor amount in the atmosphere in the glass melting furnace 1 (target value).

### Examples

In Examples of the present invention, an evaluation test in which, while a water vapor amount in an atmosphere in a glass melting furnace was adjusted, glass raw materials having a glass composition of OA-31 (alkali-free glass) manufactured by Nippon Electric Glass Co., Ltd. were melted in the glass melting furnace only by electric heating was performed. In Examples of the present invention, the water vapor amount in the atmosphere in the glass melting furnace was adjusted to 15 g/Nm³ or less by supplying a dry air at normal temperature into the glass melting furnace at a position corresponding to an exposed portion of molten glass in which the molten glass was prevented from being covered with the glass raw materials. In addition, in Comparative Example, an evaluation test in which, while the water vapor amount in the atmosphere in the glass melting furnace was not adjusted, the glass raw materials having the same glass composition as in Examples were melted in the glass melting furnace only by electric heating was performed. Moreover, in each of the evaluation tests, after the glass raw materials were melted, the resultant molten glass was formed into a sheet glass by an overflow down-draw method, and a water amount in the formed sheet glass was evaluated. The water amount in the sheet glass was evaluated based on β-OH (mm⁻¹). Herein, “β-OH” refers to a value obtained by measuring a transmittance of the glass with a Fourier transform infrared spectrometer (FTIR) and using the following equation.
β-OH=(1/X)log 10(T₁/T₂)
X: thickness (mm) of sheet glass
T₁: transmittance (%) at a reference wavelength of 3,846 cm⁻¹
T₂: minimum transmittance (%) around a hydroxyl group absorption wavelength of 3,600 cm⁻¹

The results of the above-mentioned evaluation tests are shown in Table 1. In Table 1, the “water vapor amount in atmosphere” refers to the water vapor amount in the atmosphere in the glass melting furnace above the molten glass. In addition, the “furnace pressure” refers to a difference in pressure (P1-P2) between a pressure P1 of the atmosphere in the glass melting furnace and a pressure (atmospheric pressure) P2 outside the glass melting furnace. Further, the “furnace temperature control” was evaluated as follows: the case in which the temperature of the molten glass was able to be kept at a desired temperature and the glass raw materials were able to be stably continuously melted was represented by Symbol “∘”; and the case in which the temperature of the molten glass was reduced and the melting amount of the glass raw materials (discharge amount of the molten glass) was reduced was represented by Symbol “x”.

TABLE 1

| | | | Water | |
|---|---|---|---|---|
| | Water vapor | | amount in | |
| | amount in | Furnace | sheet glass | Furnace |
| | atmosphere | pressure | β-OH value | temperature |
| | (g/Nm³) | (mmH₂O) | (mm⁻¹) | control |
| Comparative | 20 | 1 | 1.3 | ∘ |
| Example | | | | |
| Example 1 | 15 | 1 | 0.98 | ∘ |
| Example 2 | 10 | 1 | 0.9 | ∘ |
| Example 3 | 5 | 1 | 0.85 | ∘ |
| Example 4 | 3 | 1 | 0.83 | ∘ |
| Example 5 | 1 | 1 | 0.8 | ∘ |
| Example 6 | 0.1 | 1 | 0.7 | ∘ |
| Example 7 | 1 | 15 | 0.93 | x |
| Example 8 | 1 | 8 | 0.83 | ∘ |
| Example 9 | 1 | 3 | 0.81 | ∘ |
| Example 10 | 1 | −1 | 0.79 | ∘ |
| Example 11 | 1 | −3 | 0.78 | ∘ |
| Example 12 | 1 | −15 | 0.77 | x |

According to Table 1, it was able to be confirmed that the water amount (β-OH) in the sheet glass was smaller in each of Examples 1 to 12, in which the water vapor amount in the atmosphere in the glass melting furnace was adjusted to 15 g/Nm³ or less, than in Comparative Example, in which the water vapor amount in the atmosphere in the glass melting furnace was not adjusted. Accordingly, the sheet glasses manufactured in Examples 1 to 12 are each easily increased in strain point, and each provide a sheet glass with low compaction (about 20 ppm or less). In addition, from Example 7 and Example 12, it was able to be confirmed that, when the difference in pressure inside and outside the glass melting furnace was too large, the temperature of the molten glass was reduced, and the melting amount of the glass raw materials was reduced. Accordingly, it is found that, from the viewpoint of stably manufacturing a sheet glass with low compaction, it is preferred to, while adjusting the water vapor amount in the atmosphere in the glass melting furnace to 15 g/Nm³ or less, further adjust a difference in pressure inside and outside the glass melting furnace to from −10 mm H₂O to 10 mm H₂O as in Examples 1 to 6 and Examples 8 to 11. Even when the difference in pressure inside and outside the glass melting furnace is outside the above-mentioned range, the temperature of the molten glass can be kept at a desired temperature, for example, by supplying a preheated dry air into the glass melting furnace.

The present invention is not limited to the configurations of the above-mentioned embodiments. In addition, the action and effect of the present invention are not limited to those described above. The present invention may be modified in various forms within the range not departing from the spirit of the present invention.

While the case in which the water vapor amount in the atmosphere in the glass melting furnace is adjusted by supplying the dry gas into the glass melting furnace has been described in the above-mentioned embodiment, the supply method for the dry gas is not particularly limited. For example, it is appropriate to circulate a gas in the glass melting furnace and remove water from the gas in the circulation route. In this case, the gas from which water has been removed in the circulation route serves as the dry gas. As a method of removing water from the gas in the circulation route, there is given, for example, a method involving causing the gas to pass through a container filled with a desiccant, such as silica gel, to thereby adsorb the water onto the desiccant.

While the case in which the water vapor amount in the atmosphere in the glass melting furnace is adjusted by supplying the dry gas into the glass melting furnace has been described in the above-mentioned embodiment, the adjustment method for the water vapor amount in the atmosphere in the glass melting furnace is not limited thereto. There may be given, for example, a method involving reducing the pressure of the atmosphere in the furnace.

While the case in which the glass article to be formed by the forming device is the sheet glass or the glass roll is described in the above-mentioned embodiment, the present invention is not limited thereto. For example, the glass article to be formed by the forming device may be, for example, an optical glass part, a glass tube, a glass block, a glass fiber, or the like, and may have an arbitrary shape.

### REFERENCE SIGNS LIST

1 glass melting furnace
2 fining chamber
3 homogenization chamber
4 pot
5 forming device
6 to 9 transfer pipe
10 bottom wall part
11 electrode
12 screw feeder
13 gas duct
14 gas supply port
Gm molten glass
Gr glass raw material

1. A manufacturing method for a glass article, comprising:
a glass melting step of continuously melting glass raw materials in a glass melting furnace only by electric heating to generate molten glass; and
a forming step of forming the molten glass into a glass article,
wherein the glass melting step comprises adjusting a water vapor amount in an atmosphere in the glass melting furnace.

2. The manufacturing method for a glass article according to claim 1, wherein the glass melting step comprises adjusting the water vapor amount in the atmosphere in the glass melting furnace to 15 g/Nm³ or less.

3. The manufacturing method for a glass article according to claim 1, wherein the glass melting step comprises adjusting the water vapor amount in the atmosphere in the glass melting furnace by suppling a dry gas into the glass melting furnace.

4. The manufacturing method for a glass article according to claim 3,
wherein, in the glass melting step, the molten glass comprises an exposed portion in which a liquid surface thereof is exposed without being covered with the glass raw materials, and
wherein the dry gas is supplied into the glass melting furnace at a position corresponding to the exposed portion.

5. The manufacturing method for a glass article according to claim 1, wherein the glass melting step further comprises adjusting a difference in pressure between the atmosphere in the glass melting furnace and an atmosphere outside the glass melting furnace to from −10 mm H₂O to 10 mm H₂O.

6. The manufacturing method for a glass article according to claim 1, wherein the forming step comprises forming the molten glass into a sheet glass by a down-draw method.

7. The manufacturing method for a glass article according to claim 1, wherein the molten glass is alkali-free glass.

8. A glass melting furnace, which is configured to melt glass raw materials only by electric heating to generate molten glass, and which comprises an adjusting part configured to adjust a water vapor amount in an atmosphere in the furnace.

9. The glass melting furnace according to claim 8, wherein the adjusting part comprises a gas supply part configured to supply a dry gas into the furnace.

10. The manufacturing method for a glass article according to claim 2, wherein the glass melting step comprises adjusting the water vapor amount in the atmosphere in the glass melting furnace by suppling a dry gas into the glass melting furnace.

11. The manufacturing method for a glass article according to claim 10,
wherein, in the glass melting step, the molten glass comprises an exposed portion in which a liquid surface thereof is exposed without being covered with the glass raw materials, and
wherein the dry gas is supplied into the glass melting furnace at a position corresponding to the exposed portion.

12. The manufacturing method for a glass article according to claim 2, wherein the glass melting step further comprises adjusting a difference in pressure between the atmosphere in the glass melting furnace and an atmosphere outside the glass melting furnace to from −10 mm H₂O to 10 mm H₂O.

13. The manufacturing method for a glass article according to claim 3, wherein the glass melting step further comprises adjusting a difference in pressure between the atmosphere in the glass melting furnace and an atmosphere outside the glass melting furnace to from −10 mm H₂O to 10 mm H₂O.

14. The manufacturing method for a glass article according to claim 4, wherein the glass melting step further comprises adjusting a difference in pressure between the atmosphere in the glass melting furnace and an atmosphere outside the glass melting furnace to from −10 mm H₂O to 10 mm H₂O.

15. The manufacturing method for a glass article according to claim 10, wherein the glass melting step further comprises adjusting a difference in pressure between the atmosphere in the glass melting furnace and an atmosphere outside the glass melting furnace to from −10 mm H₂O to 10 mm H₂O.

16. The manufacturing method for a glass article according to claim 11, wherein the glass melting step further comprises adjusting a difference in pressure between the atmosphere in the glass melting furnace and an atmosphere outside the glass melting furnace to from −10 mm H₂O to 10 mm H₂O.

17. The manufacturing method for a glass article according to claim 2, wherein the forming step comprises forming the molten glass into a sheet glass by a down-draw method.

18. The manufacturing method for a glass article according to claim 3, wherein the forming step comprises forming the molten glass into a sheet glass by a down-draw method.

19. The manufacturing method for a glass article according to claim 4, wherein the forming step comprises forming the molten glass into a sheet glass by a down-draw method.

20. The manufacturing method for a glass article according to claim 5, wherein the forming step comprises forming the molten glass into a sheet glass by a down-draw method.
